(19) United States
(12) Patent Application Publication
(10) Pub. No.: US 2011/0105119 A1
(43) Pub. Date: May 5, 2011

(54) RADIO BASE STATIONS, RADIO COMMUNICATION DEVICES, METHODS FOR CONTROLLING A RADIO BASE STATION, AND METHODS FOR CONTROLLING A RADIO COMMUNICATION DEVICE

(75) Inventors: Maik Bienas, Braunschweig (DE); Andreas Schmidt, Braunschweig (DE); Hyung-Nam Choi, Hamburg (DE); Martin Hans, Bad Salzdetfurth (DE)

(73) Assignee: INFINEON TECHNOLOGIES AG, Neubiberg (DE)

(21) Appl. No.: 12/610,391

(22) Filed: Nov. 2, 2009

(51) Int. Cl. H04W 36/00

(52) U.S. Cl. 455/436

(57) ABSTRACT

In an embodiment, a radio base station is provided. The radio base station may include a message generator configured to generate a message including information specifying whether the radio base station is a radio base station which allows handover to another radio base station.

### TECHNICAL FIELD

Various embodiments relate generally to radio base stations, radio communication devices, methods for controlling a radio base station, and methods for controlling a radio communication device.

### BACKGROUND

In mobile radio communication, radio communication devices like user equipment (UE) or mobile stations (MS) resp. advanced mobile stations (AMS), for example when experiencing deteriorating reception quality from the currently serving base station (BS), for example because the radio communication device is moving from one location to another, may desire to change from the currently serving base station to another base station. This changing of serving base station (for example while the UE is in ‘RRC Connected’ mode) usually is referred to as handover (HO). Changing base stations for example while the UE is in ‘RCC Idle’ mode may also be referred to as cell re-selection. A radio communication device may perform a search for available radio base station as candidates for handover. In various situations, more than one base station may be available as a candidate for the new serving base station after a handover has been carried out. Usually, the base station with the best reception quality is chosen as the new serving base station, and the radio communication device in case that it is decided that handover shall be performed, changes to the base station with the best reception quality.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a radio base station in accordance with an embodiment;

FIG. 2 shows a radio base station in accordance with an embodiment;

FIG. 3 shows a radio communication device in accordance with an embodiment;

FIG. 4 shows a radio communication device in accordance with an embodiment;

FIG. 5 shows a flow diagram illustrating a method for controlling a radio base station in accordance with an embodiment;

FIG. 6 shows an overview of the general 3GPP Network Architecture with three different Radio Access Networks in accordance with an embodiment;

FIG. 7 shows a possible deployment scenario for three Home NodeBs in accordance with an embodiment;

FIG. 8 shows a possible deployment scenario for one legacy base station and a home base station in accordance with an embodiment;

FIG. 9 shows an E-UTRAN architecture in accordance with an embodiment;

FIG. 10 shows a protocol stack of the 3GPP LTE (Long Term Evolution) system in accordance with an embodiment;

FIG. 11 shows a diagram illustrating a change of system information in accordance with an embodiment; and

FIG. 12 shows an overview of the two E-UTRA RRC states E-UTRA RRC CONNECTED and E-UTRA RRC IDLE.

### DESCRIPTION

In various embodiments, a radio base station, for example a macro base station, legacy base station, home base station, home NodeB (HNB) or home eNodeB (HeNB), may transmit information specifying whether the radio base station is a radio base station that allows handover to another radio base station. In an embodiment, the radio base station may transmit information specifying whether the radio base station allows handover to another base station which allows access to a closed user group only. In various embodiments, a radio communication device that desires to perform handover or cell re-selection, may receive and evaluate this information in order to limit the scope of search to only those base stations to which the radio base station that is currently serving the radio communication device allows handover. In various embodiments, this may reduce the effort of the radio communication device in preparing handover or cell re-selection, because it may reduce the number of radio base stations to measure. Furthermore, a radio communication device that is currently served by a radio base station may chose not to perform handover to another radio base station that is a base station that does not allow handover to the radio base station by which the radio communication device is currently served, in order to be able to perform handover back, in case desired.

The following detailed description refers to the accompanying drawings that show, by way of illustration, specific details and embodiments in which the invention may be practiced. Other embodiments may be utilized and structural, logical, and electrical changes may be made without departing from the scope of the invention. The various embodiments are not necessarily mutually exclusive, as some embodiments can be combined with one or more other embodiments to form new embodiments. The following detailed description therefore, is not to be taken in a limiting sense, and the scope of the present invention is defined by the appended claims.

The word “exemplary” is used herein to mean “serving as an example, instance, or illustration”. Any embodiment or design described herein as “exemplary” is not necessarily to be construed as preferred or advantageous over other embodiments or designs.

A radio communication device according to various embodiments may be a device configured for wireless communication. In various embodiments, a radio communication device may be an end-user mobile device (MD). In various embodiments, a radio communication device may be any kind of mobile telephone, personal digital assistant, mobile computer, or any other mobile device configured for communication with a mobile communication base station or an access point and may be also referred to as a User Equipment (UE), a mobile station (MS) or an advanced mobile station (advanced MS, AMS), for example in accordance with IEEE 802.16m.

A radio communication device according to various embodiments may include a memory which is for example used in the processing carried out by the end-user mobile devices. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

A radio base station according to various embodiments may include a memory which is for example used in the processing carried out by the end-user mobile devices. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

The terms “coupling” or “connection” are intended to include a direct “coupling” or direct “connection” as well as an indirect “coupling” or indirect “connection”, respectively.

The term “protocol” is intended to include any piece of software that is provided to implement part of any layer of the communication definition. “Protocol” may include the functionality of one or more of the following layers: physical layer (layer 1), data link layer (layer 2), network layer (layer 3), or any other sub-layer of the mentioned layers or any upper layer.

In various embodiments, a radio base station may be configured as a macro cell base station or a legacy base station.

In various embodiments, a radio base station may be configured as a home base station, e.g. as a Home NodeB, e.g. as a Home (e)NodeB. In an example, a ‘Home NodeB’ may be understood in accordance with 3GPP (Third Generation Partnership Project) as a trimmed-down version of a cellular mobile radio base station optimized for use in residential or corporate environments (e.g., private homes, public restaurants or small office areas). In various examples throughout this description, the terms ‘Home Base Station’, ‘Home NodeB’, ‘Home eNodeB’, ‘Femto Cell’, ‘Femto Cell Base Station’ are referring to the same logical entity and will be used interchangeably throughout the entire description. Femto-Cell Base Stations (FC-BS) may be provided in accordance with a 3GPP standard, but may also be provided for any other mobile radio communication standard, for example for IEEE 802.16m.

The so-called ‘Home Base Station’ concept shall support receiving and initiating cellular calls at home, and uses a broadband connection (typically DSL (dynamic subscriber line), cable modem or fibre optics) to carry traffic to the operator's core network bypassing the macro network architecture (including legacy NodeBs or E-NodeBs, respectively), i.e. the legacy UTRAN (UMTS (Universal Mobile Telecommunications System) Terrestrial Radio Access Network) or E-UTRAN, respectively. Femto Cells shall operate with all existing and future handsets rather than requiring customers to upgrade to expensive dual-mode handsets or UMA (Unlicensed Mobile Access) devices.

From the customer's perspective, ‘Home NodeBs’ offer the user a single mobile handset with a built-in personal phonebook for all calls, whether at home or elsewhere. Furthermore, for the user, there is only one contract and one bill. Yet another effect of providing ‘Home NodeBs’ may be seen in the improved indoor network coverage as well as in the increased traffic throughput. Moreover, power consumption may be reduced as the radio link quality between a handset and a ‘Home Base Station’ may be expected to be much better than the link between a handset and legacy ‘NodeB’.

In an embodiment, access to a ‘Home NodeB’ may be allowed for a closed user group only, i.e. the communication service offering may be restricted to employees of a particular company or family members, in general, to the members of the closed user group. This kind of ‘Home Base Stations’ may be referred to as ‘Closed Subscriber Group Cells’ (CSG Cells) in 3GPP. A mobile radio cell which indicates being a CSG Cell may need to provide its CSG Identity to the mobile radio communication terminal devices (e.g. the UEs). Such a mobile radio cell may only be suitable for a mobile radio communication terminal device if its CSG Identity is e.g. listed in the mobile radio communication terminal device's CSG white list (a list of CSG Identities maintained in the mobile radio communication terminal device or in an associated smart card indicating the mobile radio cells which a particular mobile radio communication terminal device is allowed to use for communication). In various embodiments, a home base station may be a consumer device that is connected to the mobile radio core network via fixed line (e.g. DSL) or wireless to a mobile radio macro cell. It may provide access to legacy mobile devices and increase the coverage in buildings and the bandwidth per user. In various embodiments, a home base station may be run in open or closed mode. In closed mode the home base station may provide access to a so-called closed subscriber group (CSG) only. Examples for such closed subscriber groups are families or some or all employees of a company, for example.

As a ‘Femto Cell’ entity or ‘Home Base Station’ entity will usually be a box of small size and physically under control of the user, in other words, out of the MNO's (mobile network operator) domain, it could be used nomadically, i.e. the user may decide to operate it in his apartment, but also in a hotel when he is away from home, e.g. as a business traveler. Additionally a ‘Home NodeB’ may be operated only temporarily, i.e. it can be switched on and off from time to time, e.g. because the user does not want to operate it over night or when he leaves his apartment.

Various embodiments are provided for devices, and various embodiments are provided for methods. It will be understood that basic properties of the devices also hold for the methods and vice versa. Therefore, for sake of brevity, duplicate description of such properties may be omitted.

In various embodiments, a (radio) resource of one or more (radio) resources will be understood as for example transmission frequency, transmission modulation scheme, transmission code, and/or transmission time slot, or any other feature of a transmitted signal.

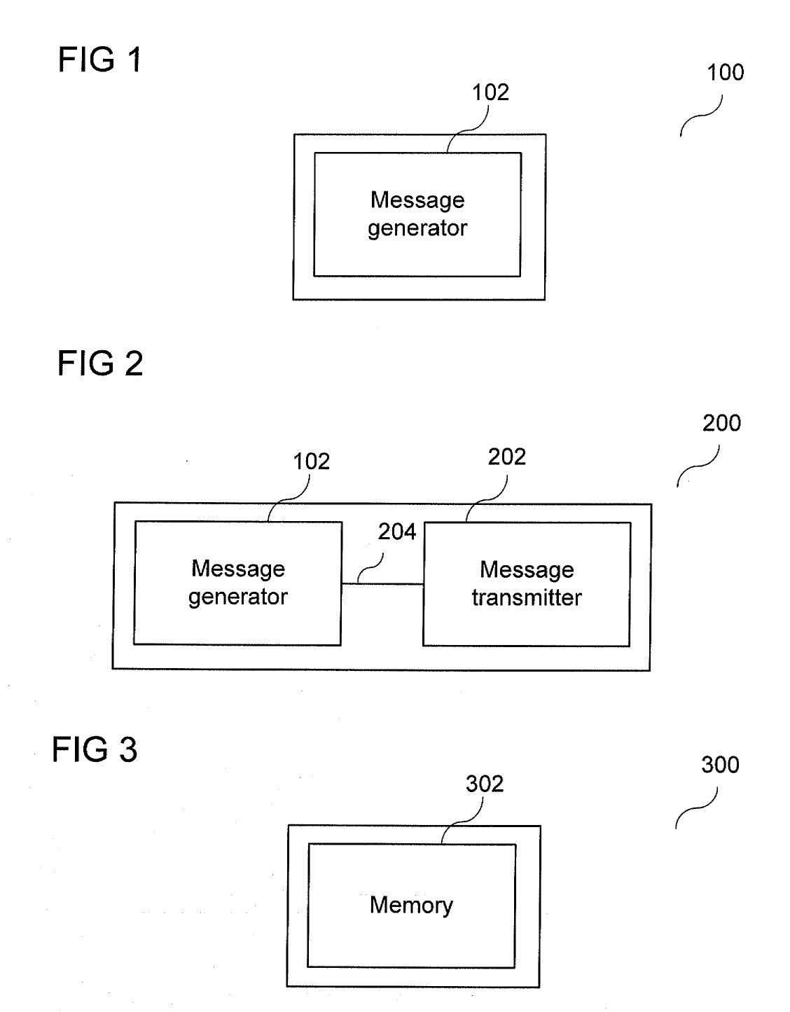

FIG. 1 shows a radio base station 100 in accordance with an embodiment. The radio base station 100 may include a message generator 102 configured to generate a message comprising information specifying whether the radio base station 100 is a radio base station which allows handover to another radio base station.

In various embodiments, it will be understood that a radio base station is either a radio base station which allows handover to another radio base station or a radio base station which does not allow handover to another radio base station independent from the situation at any radio communication device, for example independent from the situation at any radio communication device the radio base station currently provides service for.

In various embodiments, changing of serving base station (for example while the UE is in ‘RRC Connected’ mode) may be referred to as handover (HO). Changing base stations for example while the UE is in ‘RCC Idle’ mode may also be referred to as cell re-selection.

In various embodiments, the radio base station 100 may be a macro base station.

In various embodiments, the radio base station 100 may be a legacy base station.

In various embodiments, the radio base station 100 may be a NodeB.

In various embodiments, the radio base station 100 may be an enhanced NodeB (eNodeB).

In various embodiments, the radio base station 100 may be a home base station.

In various embodiments, the radio base station 100 may be a home NodeB (HNB).

In various embodiments, the radio base station 100 may be a home eNodeB (HeNB).

In various embodiments, the message generator 102 may further be configured to generate a message comprising information specifying whether the radio base station 100 is a radio base station which allows handover to another pre-defined radio base station.

In various embodiments, the message generator 102 may further be configured to generate a message including information specifying whether the radio base station 100 is a radio base station which allows handover to another radio base station of a pre-defined type.

In various embodiments, the pre-defined type may be a type of radio base station that allows connection only to one or more pre-defined radio communication devices.

In various embodiments, the pre-defined type may be a type of a closed subscriber group (CSG).

FIG. 2 shows a radio base station 200 in accordance with an embodiment. The radio base station 200 may include a message generator 102 and a message transmitter 202. The message generator 102 and the message transmitter 202 may be coupled with each other, e.g. via an electrical connection 204 such as e.g. a cable or a computer bus or via any other suitable electrical connection to exchange electrical signals. The message generator 102, similar to the message generator 102 of the radio base station 100 explained with reference to FIG. 1, may be configured to generate a message including information specifying whether the radio base station 200 is a radio base station which allows handover to another radio base station. The message transmitter 202 may be configured to transmit a message generated by the message generator 102.

In various embodiments, the message transmitter 202 may be further configured to transmit signals according to at least one radio communication technology of one of the following radio communication technology families:
a Short Range radio communication technology family;
a Metropolitan Area System radio communication technology family;
a Cellular Wide Area radio communication technology family;
a radio communication technology family which includes a radio communication technology in which the access to radio resources is provided in a random manner; and
a radio communication technology family which includes a radio communication technology in which the access to radio resources is provided in a centrally controlled manner.

In various embodiments, the message transmitter 202 may be further configured to transmit signals according to at least one of the following radio communication technologies: a Bluetooth radio communication technology, an Ultra Wide Band (UWB) radio communication technology, a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((HIgh PErformance Radio LAN; an alternative ATM-like 5 GHz standardized technology), IEEE 802.11a (5 GHz), IEEE 802.11g (2.4 GHz), IEEE 802.11n, IEEE 802.11 VHT (VHT=Very High Throughput), e.g. IEEE 802.11ac for VHT below 6 GHz and IEEE 802.11ad for VHT at 60 GHz, a Worldwide Interoperability for Microwave Access (WiMax) (e.g. according to an IEEE 802.16 radio communication standard, e.g. WiMax fixed or WiMax mobile), WiPro, HiperMAN (High Performance Radio Metropolitan Area Network), IEEE 802.16m Advanced Air Interface, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (long term Evolution), 3GPP LTE Advanced (long term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (long term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, and Unlicensed Mobile Access (UMA, also referred to as also referred to as 3GPP Generic Access Network, or GAN standard)).

In various embodiments, the message transmitter 202 may further be configured to broadcast the message.

In various embodiments, the message transmitter 202 may further be configured to transmit the message via a System Information Message of the radio base station 200, as will be explained in more detail below.

In various embodiments, the message transmitter 202 may further be configured to broadcast the message to a radio communication device camping on still another radio base station.

In various embodiments, the message transmitter 202 may further be configured to broadcast the message to a radio communication device camping on the radio base station 200.

In various embodiments, the message transmitter 202 may further be configured to transmit the message on a common control channel.

In various embodiments, the message transmitter 202 may further be configured to transmit the message on a dedicated control channel.

In various embodiments, a message generated by the message generator 200 may further include at least one of the following information: a maximum number of radio base stations a radio communication device shall measure for handover or cell-re-selection preparation; a maximum number of radio base stations a radio communication device shall report measurement results on for preparing handover; a maximum number of radio base stations of a pre-defined type a radio communication device shall measure for preparing handover; a maximum number of radio base stations of a pre-defined type a radio communication device shall report measurement results on for preparing handover; a maximum number of closed subscriber group radio base stations a radio communication device shall measure for preparing handover; a maximum number of closed subscriber group radio base stations a radio communication device shall report measurement results on for preparing handover; a quality threshold for reporting a measurement; a reference signal received power threshold for reporting a measurement; a reference signal received quality threshold for reporting a measurement; a leaving condition for leaving a radio base station; an entering condition for entering a radio base station; and a minimum stable reception threshold for reporting a measurement.

FIG. 3 shows a radio communication device 300 in accordance with an embodiment. The radio communication device 300 may include a memory 302 configured to store information specifying whether a radio base station is a radio base station which allows handover to another radio base station.

In various embodiments, the radio communication device may be a mobile station (MS), advanced mobile station (advanced MS, AMS), a user equipment (UE), a cell phone, a personal digital assistant (PDA), or a handheld computer.

In various embodiments, the information may be information specifying whether the radio base station is a radio base station which allows handover to another pre-defined radio base station.

In various embodiments, the information may be information specifying whether the radio base station is a radio base station which allows handover to another radio base station of a pre-defined type.

In various embodiments, the pre-defined type may be a type of radio base station that allows connection only to one or more pre-defined radio communication devices.

In various embodiments, the pre-defined type may be a type of a closed subscriber group.

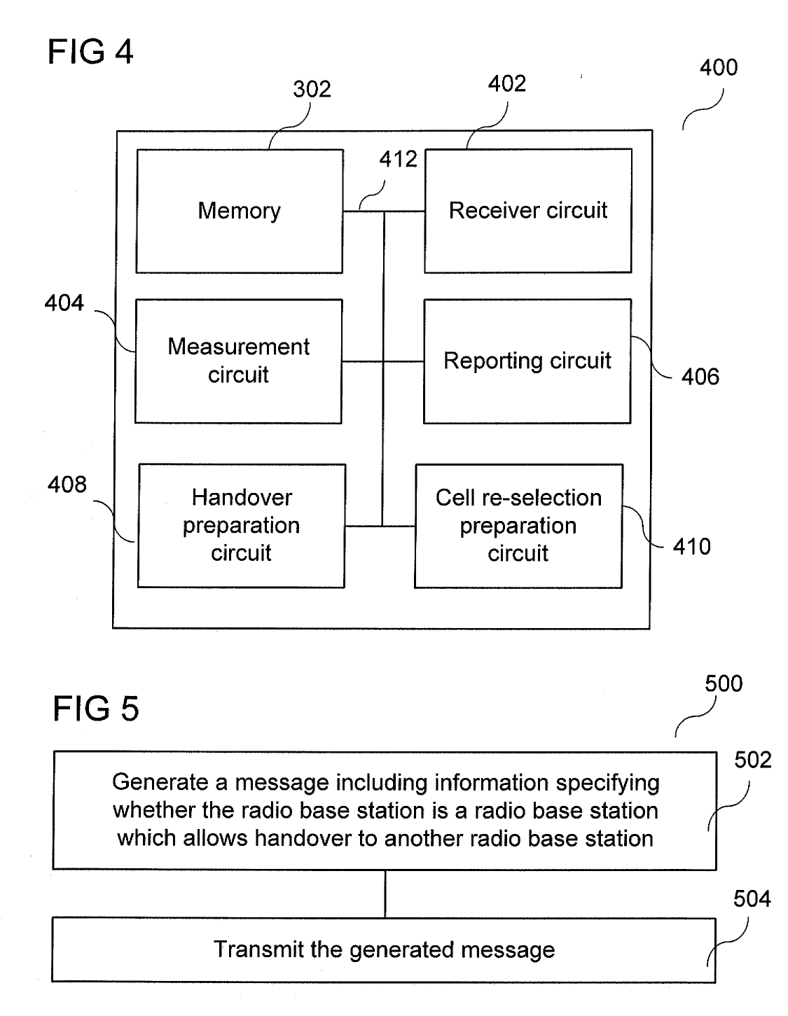

FIG. 4 shows a radio communication device 400 in accordance with an embodiment. The radio communication device 400, similar to the radio communication device 300 of FIG. 3, may include a memory 302. The radio communication device 400 may further include a receiver circuit 402, as will be explained in more detail below. The radio communication device 400 may further include a measurement circuit 404, as will be explained in more detail below. The radio communication device 400 may further include a reporting circuit 406, as will be explained in more detail below. The radio communication device 400 may further include a handover preparation circuit 408, as will be explained in more detail below. The radio communication device 400 may further include a cell re-selection circuit 410, as will be explained in more detail below. The memory 302, the receiver circuit 402, the measurement circuit 404, the reporting circuit 406, the handover preparation circuit 408, and the cell re-selection circuit 410 may be coupled with each other, e.g. via an electrical connection 412 such as e.g. a cable or a computer bus or via any other suitable electrical connection to exchange electrical signals.

In various embodiments, the receiver circuit 402 may be configured to receive the information specifying whether a radio base station is a radio base station which allows handover to another radio base station.

In various embodiments, the receiver circuit 402 may be further configured to receive signals according to at least one radio communication technology of one of the following radio communication technology families:
a Short Range radio communication technology family;
a Metropolitan Area System radio communication technology family;
a Cellular Wide Area radio communication technology family;
a radio communication technology family which includes a radio communication technology in which the access to radio resources is provided in a random manner; and
a radio communication technology family which includes a radio communication technology in which the access to radio resources is provided in a centrally controlled manner.

In various embodiments, the receiver circuit 402 may be further configured to receive signals according to at least one of the following radio communication technologies: a Bluetooth radio communication technology, an Ultra Wide Band (UWB) radio communication technology, a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((HIgh PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput), e.g. IEEE 802.11ac for VHT below 6 GHz and IEEE 802.11ad for VHT at 60 GHz, a Worldwide Interoperability for Microwave Access (WiMax) (e.g. according to an IEEE 802.16 radio communication standard, e.g. WiMax fixed or WiMax mobile), WiPro, HiperMAN (High Performance Radio Metropolitan Area Network), IEEE 802.16m Advanced Air Interface, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (long term Evolution), 3GPP LTE Advanced (long term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (long term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, and Unlicensed Mobile Access (UMA, also referred to as also referred to as 3GPP Generic Access Network, or GAN standard)).

In various embodiments, the receiver circuit 402 may further be configured to receive the information by broadcast.

In various embodiments, the receiver circuit 402 may further be configured receive the information via a System Information Message of a radio base station, as will be explained in more detail below.

In various embodiments, the receiver circuit 402 may further be configured to receive the information on a common control channel.

In various embodiments, the receiver circuit 402 may further be configured to receive the information on a dedicated control channel.

In various embodiments, the receiver circuit 402 may further be configured to receive the information via dedicated signaling (e.g., as part of an RRC measurement configuration).

In various embodiments, the memory 302 may further be configured to store at least one of the following information: a maximum number of radio base stations a radio communication device shall measure for preparation of handover or preparation of cell re-selection; a maximum number of radio base stations a radio communication device shall report measurement results on for preparation of handover or preparation of cell re-selection; a maximum number of radio base stations of a pre-defined type a radio communication device shall measure for preparation of handover or preparation of cell re-selection; a maximum number of radio base stations of a pre-defined type a radio communication device shall report measurement results on for preparation handover or preparation of cell re-selection; a maximum number of closed subscriber group radio base stations a radio communication device shall measure for preparation of handover or preparation of cell re-selection; a maximum number of closed subscriber group radio base stations a radio communication device shall report measurement results on for preparation of handover or preparation of cell re-selection; a quality threshold for reporting a measurement; a reference signal received power threshold for reporting a measurement; a reference signal received quality threshold for reporting a measurement; a leaving condition for leaving a radio base station; an entering condition for entering a radio base station; and a minimum stable reception threshold for reporting a measurement.

In various embodiments, the receiver circuit 402 may further be configured to receive at least one of the following information: a maximum number of radio base stations a radio communication device shall measure for preparation of handover or preparation of cell re-selection; a maximum number of radio base stations a radio communication device shall report measurement results on for preparation of handover or preparation of cell re-selection; a maximum number of radio base stations of a pre-defined type a radio communication device shall measure for preparation of handover or preparation of cell re-selection; a maximum number of radio base stations of a pre-defined type a radio communication device shall report measurement results on for preparation of handover or preparation of cell re-selection; a maximum number of closed subscriber group radio base stations a radio communication device shall measure for preparation of handover or preparation of cell re-selection; a maximum number of closed subscriber group radio base stations a radio communication device shall report measurement results on for preparation of handover or preparation of cell re-selection; a quality threshold for reporting a measurement; a reference signal received power threshold for reporting a measurement; a reference signal received quality threshold for reporting a measurement; a leaving condition for leaving a radio base station; an entering condition for entering a radio base station; and a minimum stable reception threshold for reporting a measurement.

In various embodiments, the measurement circuit 404 may be configured to measure reception quality of a radio base station.

In various embodiments, the measurement circuit 404 may further be configured to measure reception quality of a radio base station which is determined based on the stored information.

In various embodiments, the reporting circuit 406 may be configured to report a result of a measurement of the measurement circuit 404.

In various embodiments, the reporting circuit 406 may be configured to report the result to a base station.

In various embodiments, the reporting circuit 406 may be configured to report the result to the serving base station.

In various embodiments, the reporting circuit 406 may further be configured to report a result of a measurement of the measurement circuit 404 based on the stored information.

In various embodiments, the handover preparation circuit 408 resp. the cell re-selection circuit 410 may be configured to determine a radio base station as a candidate for handover resp. cell re-selection.

In various embodiments, the handover preparation circuit 408 resp. the cell re-selection circuit 410 may further be configured to determine a radio base station which is of a type different from the pre-defined type as a candidate for handover resp. cell re-selection, in case the information specifies that the radio base station is a radio base station which does not allow handover to another radio base station of the pre-defined type.

In various embodiments, the handover preparation circuit 408 resp. the cell re-selection circuit 410 is further configured to determine a radio base station which allows handover to another radio base station as a candidate for handover.

It will be understood that although the handover preparation circuit 408 and the cell re-selection circuit 410 are explained as being two circuits, in various embodiments, a combined circuit combining some or all of the tasks and properties of the handover preparation circuit 408 and the cell-reselection circuit 410 may be provided.

In various embodiments, a radio base station, configured to transmit information specifying whether the radio base station is a radio base station which allows handover to another radio base station, may be provided.

In various embodiments, a radio communication device, configured to store information specifying whether a radio base station is a radio base station which allows handover to another radio base station, may be provided.

In various embodiments, a method for controlling a radio base station may be provided. The method may include generating a message comprising information specifying whether the radio base station is a radio base station which allows handover to another radio base station.

FIG. 5 shows a flow diagram 500 illustrating a method for controlling a radio base station in accordance with an embodiment. In 502, a message including information specifying whether the radio base station is a radio base station which allows handover to another radio base station may be generated. In 504, the generated message may be transmitted.

In various embodiments, the radio base station may be a legacy base station.

In various embodiments, the radio base station may be a NodeB.

In various embodiments, the radio base station may be an enhanced NodeB (eNodeB).

In various embodiments, the radio base station may be a home base station.

In various embodiments, the radio base station may be a home NodeB (HNB).

In various embodiments, the radio base station may be a home eNodeB (HeNB).

In various embodiments, a message including information specifying whether the radio base station is a radio base station which allows handover to another pre-defined radio base station may be generated.

In various embodiments, a message including information specifying whether the radio base station is a radio base station which allows handover to another radio base station of a pre-defined type may be generated.

In various embodiments, the pre-defined type may be a type of radio base station that allows connection only to one or more pre-defined radio communication devices.

In various embodiments, the pre-defined type may be a type of a closed subscriber group.

In various embodiments, the message may be transmitted according to at least one radio communication technology of one of the following radio communication technology families:
a Short Range radio communication technology family;
a Metropolitan Area System radio communication technology family;
a Cellular Wide Area radio communication technology family;
a radio communication technology family which includes a radio communication technology in which the access to radio resources is provided in a random manner; and
a radio communication technology family which includes a radio communication technology in which the access to radio resources is provided in a centrally controlled manner.

In various embodiments, the message may be transmitted according to at least one of the following radio communication technologies: a Bluetooth radio communication technology, an Ultra Wide Band (UWB) radio communication technology, a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((HIgh PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput), e.g. IEEE 802.11ac for VHT below 6 GHz and IEEE 802.11ad for VHT at 60 GHz, a Worldwide Interoperability for Microwave Access (WiMax) (e.g. according to an IEEE 802.16 radio communication standard, e.g. WiMax fixed or WiMax mobile), WiPro, HiperMAN (High Performance Radio Metropolitan Area Network), IEEE 802.16m Advanced Air Interface, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (long term Evolution), 3GPP LTE Advanced (long term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (long term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, and Unlicensed Mobile Access (UMA, also referred to as also referred to as 3GPP Generic Access Network, or GAN standard)).

In various embodiments, the message may be broadcasted.

In various embodiments, the message may be transmitted via a System Information Message of the radio base station, as will be explained in more detail below.

In various embodiments, the message may be broadcasted to a radio communication device camping on still another radio base station.

In various embodiments, the message may be broadcasted to a radio communication device camping on the radio base station.

In various embodiments, the message may be transmitted on a common control channel.

In various embodiments, the message may be transmitted on a dedicated control channel.

In various embodiments, the message may be transmitted via dedicated signaling as part of an RRC measurement configuration.

In various embodiments, the message may further include at least one of the following information: a maximum number of radio base stations a radio communication device shall measure for preparation of handover or preparation of cell re-selection; a maximum number of radio base stations a radio communication device shall report measurement results on for preparation of handover or preparation of cell re-selection; a maximum number of radio base stations of a pre-defined type a radio communication device shall measure for preparation of handover or preparation of cell re-selection; a maximum number of radio base stations of a pre-defined type a radio communication device shall report measurement results on for preparation of handover or preparation of cell re-selection; a maximum number of closed subscriber group radio base stations a radio communication device shall measure for preparation of handover or preparation of cell re-selection; a maximum number of closed subscriber group radio base stations a radio communication device shall report measurement results on for preparation of handover or preparation of cell re-selection; a quality threshold for reporting a measurement; a reference signal received power threshold for reporting a measurement; a reference signal received quality threshold for reporting a measurement; a leaving condition for leaving a radio base station; an entering condition for entering a radio base station; and a minimum stable reception threshold for reporting a measurement.

In various embodiments, a method for controlling a radio communication device may be provided. The method may include storing information specifying whether a radio base station is a radio base station which allows handover to another radio base station.

In various embodiments, the radio communication device may be a mobile station (MS), advanced mobile station (advanced MS, AMS), a user equipment (UE), a cell phone, a personal digital assistant (PDA), or a handheld computer.

In various embodiments, the information may be information specifying whether the radio base station is a radio base station which allows handover to another pre-defined radio base station.

In various embodiments, the information may be information specifying whether the radio base station is a radio base station which allows handover to another radio base station of a pre-defined type.

In various embodiments, the pre-defined type may be a type of radio base station that allows connection only to one or more pre-defined radio communication devices.

In various embodiments, the pre-defined type may be a type of a closed subscriber group.

In various embodiments, the method for controlling a radio communication device may further include receiving the information specifying whether a radio base station is a radio base station which allows handover to another radio base station.

In various embodiments, the information may be received according to at least one radio communication technology of one of the following radio communication technology families:
a Short Range radio communication technology family;
a Metropolitan Area System radio communication technology family;
a Cellular Wide Area radio communication technology family;
a radio communication technology family which includes a radio communication technology in which the access to radio resources is provided in a random manner; and
a radio communication technology family which includes a radio communication technology in which the access to radio resources is provided in a centrally controlled manner.

In various embodiments, the information may be received according to at least one of the following radio communication technologies: a Bluetooth radio communication technology, an Ultra Wide Band (UWB) radio communication technology, a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((HIgh PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput), e.g. IEEE 802.11ac for VHT below 6 GHz and IEEE 802.11ad for VHT at 60 GHz, a Worldwide Interoperability for Microwave Access (WiMax) (e.g. according to an IEEE 802.16 radio communication standard, e.g. WiMax fixed or WiMax mobile), WiPro, HiperMAN (High Performance Radio Metropolitan Area Network), IEEE 802.16m Advanced Air Interface, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (long term Evolution), 3GPP LTE Advanced (long term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (long term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, and Unlicensed Mobile Access (UMA, also referred to as also referred to as 3GPP Generic Access Network, or GAN standard)).

In various embodiments, the information may be received by broadcast.

In various embodiments, the information may be received via a System Information Message of a radio base station, as will be explained in more detail below.

In various embodiments, the information may be received on a common control channel.

In various embodiments, the information may be received on a dedicated control channel.

In various embodiments, the information may be received via dedicated signaling as part of an RRC measurement configuration.

In various embodiments, furthermore at least one of the following information may be stored: a maximum number of radio base stations a radio communication device shall measure for preparation of handover or preparation of cell re-selection; a maximum number of radio base stations a radio communication device shall report measurement results on for preparation of handover or preparation of cell re-selection; a maximum number of radio base stations of a pre-defined type a radio communication device shall measure for preparation of handover or preparation of cell re-selection; a maximum number of radio base stations of a pre-defined type a radio communication device shall report measurement results on for preparation of handover or preparation of cell re-selection; a maximum number of closed subscriber group radio base stations a radio communication device shall measure for preparation of handover or preparation of cell re-selection; a maximum number of closed subscriber group radio base stations a radio communication device shall report measurement results on for preparation of handover or preparation of cell re-selection; a quality threshold for reporting a measurement; a reference signal received power threshold for reporting a measurement; a reference signal received quality threshold for reporting a measurement; a leaving condition for leaving a radio base station; an entering condition for entering a radio base station; and a minimum stable reception threshold for reporting a measurement.

In various embodiments, furthermore at least one of the following information may be received: a maximum number of radio base stations a radio communication device shall measure for preparation of handover or preparation of cell re-selection; a maximum number of radio base stations a radio communication device shall report measurement results on for preparation of handover or preparation of cell re-selection; a maximum number of radio base stations of a pre-defined type a radio communication device shall measure for preparation of handover or preparation of cell re-selection; a maximum number of radio base stations of a pre-defined type a radio communication device shall report measurement results on for preparation of handover or preparation of cell re-selection; a maximum number of closed subscriber group radio base stations a radio communication device shall measure for preparation of handover or preparation of cell re-selection; a maximum number of closed subscriber group radio base stations a radio communication device shall report measurement results on for preparation of handover or preparation of cell re-selection; a quality threshold for reporting a measurement; a reference signal received power threshold for reporting a measurement; a reference signal received quality threshold for reporting a measurement; a leaving condition for leaving a radio base station; an entering condition for entering a radio base station; and a minimum stable reception threshold for reporting a measurement.

In various embodiments, the method for controlling a radio communication device may further include measuring reception quality of a radio base station.

In various embodiments, reception quality of a radio base station which is determined based on the stored information may be measured.

In various embodiments, the method for controlling a radio communication device may further include reporting a result of a measurement of the measurement circuit.

In various embodiments, the result may be reported to a base station.

In various embodiments, the result may be reported to the serving base station.

In various embodiments, the result of a measurement of the measurement circuit may be reported based on the stored information.

In various embodiments, the method for controlling a radio communication device may further include determining a radio base station as a candidate for handover or cell re-selection.

In various embodiments, a radio base station which is of a type different from the pre-defined type may be determined as a candidate for handover or cell re-selection, in case the information specifies that the radio base station is a radio base station which does not allow handover to another radio base station of the pre-defined type.

In various embodiments, a radio base station which allows handover to another radio base station may be determined as a candidate for handover or cell re-selection.

In various embodiments, a method for controlling a radio base station, the method including transmitting information specifying whether the radio base station is a radio base station which allows handover to another radio base station, may be provided.

In various embodiments, a method for controlling a radio communication device, the method including storing information specifying whether a radio base station is a radio base station which allows handover to another radio base station, may be provided.

A current topic in the 3GPP standardization committees is the further development of 3G UMTS towards a mobile radio communication system optimized for packet data transmission by improving both system capacity and spectral efficiency. In 3GPP, the activities in this regard are summarized under the general term LTE (=Long Term Evolution). The aim for this future technology is—amongst others—to significantly increase the maximum net transmission rate, for example to 100 Mbps in the downlink transmission direction (tower to handset) and to 50 Mbps in the uplink transmission direction (handset to tower). To improve transmission via the air interface, various techniques have been specified. MIMO (Multiple Input-Multiple Output) is one of the techniques in LTE. MIMO is an antenna technology in which for example up to a maximum number of antennas (maximum configuration), for example up to 4 antennas, may be used at both the eNodeB (base station in LTE) and UE (mobile radio communication terminal) side. With MIMO multiple independent data streams may be transmitted in parallel using the same time-frequency resource. To distinguish the data streams sharing the same time-frequency resource at the receiving end, spatial division multiplexing may be applied.

Additionally, for LTE new multiple access methods may be applied. For the downlink transmission direction OFDMA (Orthogonal Frequency Division Multiple Access) in combination with TDMA (Time Division Multiple Access) may be applied. Uplink data transmission may be based on SC-FDMA (Single Carrier Frequency Division Multiple Access) in combination with TDMA. The transmitter and receiver of LTE devices may be realized using IFFT/FFT (inverse fast Fourier transform/fast Fourier transform) digital signal processing.

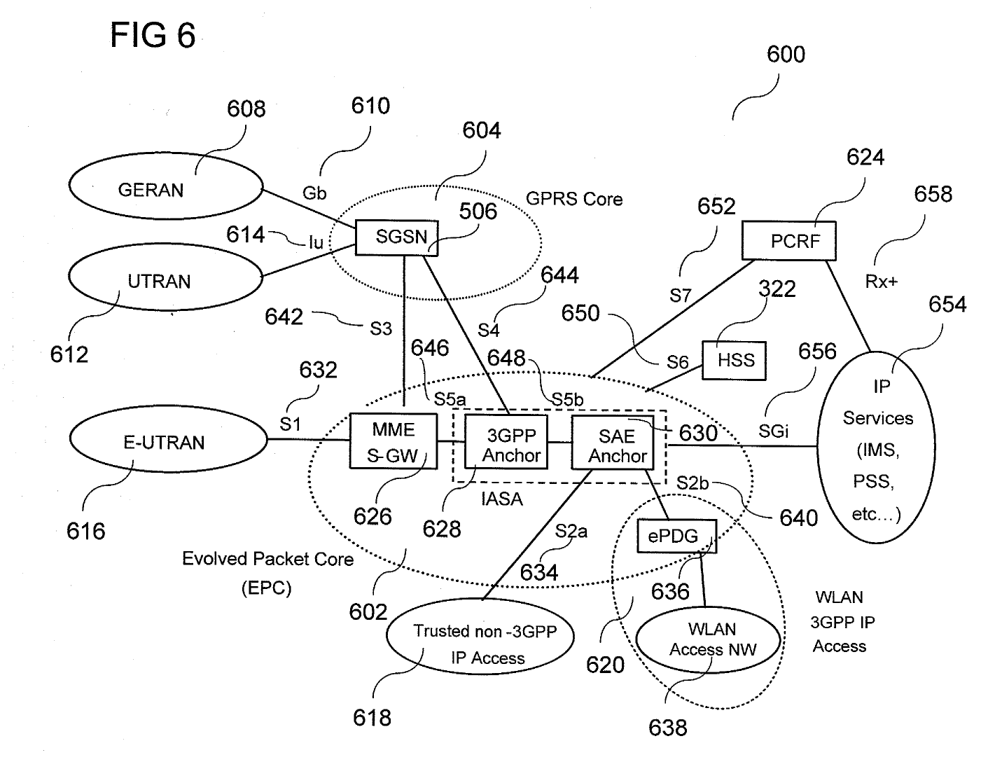

FIG. 6 shows an overview of a general 3GPP Network Architecture 600 with three different Radio Access Networks (RANs). The 3GPP Network Architecture 600 may include an Evolved Packet Core (EPC) 602 and a General Packet Radio Service (GPRS) Core 604, which may be connected with each other by various interfaces, as will be described in more detail below. As shown in the exemplary diagram of the Logical High Level Network Architecture with three different Radio Access Networks (RANs) as defined by 3GPP as shown in FIG. 6, the GPRS Core 604 may include a Serving GPRS Support Node (SGSN) 606, which may be coupled to different Radio Access Networks, such as e.g. to a GSM EDGE Radio Access Network (GERAN) 608 (which may also be referred to as 2G or 2.5G) via a Gb interface 610, and/or to a UMTS Terrestrial Radio Access Network (UTRAN) 612 via an Iu interface 614. In an embodiment, UTRAN may stand for UMTS Terrestrial Radio Access Network and may be a collective term for the NodeBs and Radio Network Controllers (RNCs) which may make up the UMTS radio access network. This communications network, commonly referred to as 3G, may carry many traffic types from real-time Circuit Switched to IP based Packet Switched. The UTRAN may contain at least one NodeB that may be connected to at least one Radio Network Controller (RNC). An RNC may provide control functionalities for one or more NodeB(s). A NodeB and an RNC may be the same device, although typical implementations may have a separate RNC located in a central location serving multiple NodeBs. An RNC together with its corresponding NodeBs may be called the Radio Network Subsystem (RNS). There may be more than one RNS provided per UTRAN.

Furthermore, in an embodiment, the following entities or components may be provided in the general 3GPP Network Architecture 600:
an evolved UMTS Terrestrial Radio Access Network (E-UTRAN) 616;
a trusted non-3GPP Internet Protocol (IP) access network 618 and connected therewith trusted non-3GPP Internet Protocol (IP) devices, in other words, trusted non-3GPP devices which may access the EPC 602 using the Internet Protocol stack;
a Wireless Local Area network (WLAN) 3GPP Internet Protocol (IP) access network 620 and connected therewith Wireless Local Area network (WLAN) 3GPP Internet Protocol (IP) devices, in other words, WLAN 3GPP devices which may access the EPC 602 using the Internet Protocol stack;
a Home Subscriber Server (HSS) 622; and
a Policy and Charging Rules Function (PCRF) entity 624.

E-UTRAN may be understood as being the new 3GPP Radio Access Network for LTE (3.9G) that is currently being worked on. The proposed E-UTRA air interface may use OFDMA for the downlink transmission direction (tower to handset) and Single Carrier FDMA (SC-FDMA) for the uplink transmission direction (handset to tower). It may employ MIMO (Multiple-Input Multiple-Output) with a plurality of antennas, e.g. with up to four antennas per station. The use of OFDM (Orthogonal Frequency Division Multiplexing) may enable E-UTRA to be much more flexible in its use of spectrum than the older CDMA based systems, such as e.g. UTRAN. OFDM may have a link spectral efficiency greater than CDMA, and when combined with modulation formats such as 64QAM (Quadrature Amplitude Modulation), and techniques as MIMO, E-UTRA may be more efficient than W-CDMA (Wideband CDMA) with HSDPA (High Speed Downlink Packet Access) and HSUPA (High Speed Uplink Packet Access).

Furthermore, as will be described in more detail below, the EPC 602 may include a Mobility Management Entity (MME) and a Serving Gateway (S-GW) (in FIG. 6 shown as one entity MME S-GW 626; however, the MME and the S-GW may also be implemented in separate devices), a 3GPP Anchor entity 628 and an SAE (System Architecture Evolution) Anchor entity 630.

In an embodiment, the E-UTRAN 616 may be connected to the MME S-GW 626 in the EPC 602 via an S1 interface 632.

Furthermore, the trusted non-3GPP IP entity 618 may be connected to the SAE Anchor entity 630 via an S2a interface 634. In an embodiment, the S2a interface 634 may be based on the Proxy Mobile IPv6 (PMIP) and in order to support accesses that do not support PMIP also Mobile IPv4.

The WLAN entity 620 may include an ePDG (Evolved Packet Data Gateway) 636 and a WLAN access network 638. The ePDG 636 may be connected to the SAE Anchor entity 630 via an S2b interface 640, which may provide the user plane with related control and mobility support between ePDG 636 and a Packet Data Network (PDN) Gateway of the EPC 602. In an embodiment, the S2b interface 640 may be based on the Proxy Mobile IPv6 (PMIP).

Furthermore, the SGSN 606 may be connected to the MME S-GW 626 in the EPC 602 via an S3 interface 642, which may provide and enable a user and bearer information exchange for inter 3GPP access network mobility in idle and/or active state. In an embodiment, the S3 interface 642 may be based on the GPRS tunneling protocol (GTP) and the Gn interface as it may be provided between SGSNs. The SGSN 606 may further be connected to the 3GPP Anchor entity 628 via an S4 interface 644, which may provide the user plane with related control and mobility support between the GPRS Core and the 3GPP Anchor function of the S-GW and may be based on the GTP protocol and the Gn reference point as provided between SGSN and GGSN.

The MME S-GW 626 may be connected to the 3GPP Anchor entity 628 via an S5a interface 646 and the 3GPP Anchor entity 628 may be connected to the SAE Anchor entity 630 via an S5b interface 648.

Furthermore, the HSS 622 may be connected to the EPC 602 via an S6 interface 650, which may provide or enable transfer of subscription and authentication data for authenticating/authorizing user access to the evolved system (AAA interface) between the MME and the HSS 622.

The PCRF 624 may be connected to the EPC 602 via an S7 interface 652, which may provide transfer of Quality of Service (QoS) policy and charging rules from the PCRF 624 to the Policy and Charging Enforcement Function (PCEF) in the PDN Gateway of the EPC 602. In an embodiment, the S7 interface 652 may be based on the Gx interface.

IP services such as e.g. (3G) IP Multimedia Subsystem (IMS), (3G) Packet Switched Streaming (PSS), etc., may be provided via an SGi interface 656 to the SAE Anchor entity 630 and/or via an Rx+ interface 658 to the PCRF 624. In an embodiment, the SGi interface 656 may be the interface between the PDN Gateway and the packet data network. The packet data network may be an operator external public or private packet data network or an intra operator packet data network, e.g. for provision of IP services such as e.g. of IMS. The SGi interface 656 may correspond to the Gi and Wi interfaces and support any 3GPP or non-3GPP access. The Rx+ interface 658 may correspond to the Rx interface and is the interface between the IP services and the PCRF 624.

In 3GPP (3^{rd} Generation Partnership Project), concepts are developed for supporting the deployment of ‘Home Base Station’, for example for so-called ‘Home NodeBs’ or ‘Home eNodeBs’, for the following Radio Access Technologies, for example:
3G UMTS (UMTS based on Code Division Multiple Access (CDMA), also referred to as ‘UTRA’ in 3GPP terminology);
3.9G LTE (Long Term Evolution, also referred to as ‘E-UTRA’ in 3GPP terminology).

A ‘Home Base Station’ (or Home NodeB (HNB) or Home eNodeB (HeNB) in 3GPP terminology) may be understood as a trimmed-down version of a base station optimized for use in residential or corporate environments (e.g., private homes, public restaurants or small office areas).

In various embodiments, the terms ‘Home Base Station’, ‘Home NodeB’ (for UMTS), ‘Home eNodeB’ (for LTE), and ‘Femto Cell’ may refer to the same logical entity and the terms may be used interchangeably.

So-called Home Base Stations or Femto-Cells may be designed to be installed by the customer himself within his premises e.g., in a ‘plug-and-play’ manner. As the Femto Cell box may be physically solely under the control of the customer, it may be moved around and even carried to locations different from the customer's house.

From the customer's perspective, Home NodeBs may offer the user a way to use a single mobile handset with a built-in personal phonebook for all calls, whether at home or elsewhere. Furthermore, for the user, there may be only one contract and one bill. Yet another effect of providing Home NodeBs may be seen in the improved indoor network coverage as well as in the increased traffic throughput. Moreover, power consumption may be reduced as the radio link quality between a handset and a Home Base Station may be better than the link between a handset and legacy NodeB, which may be a few hundred meters away.

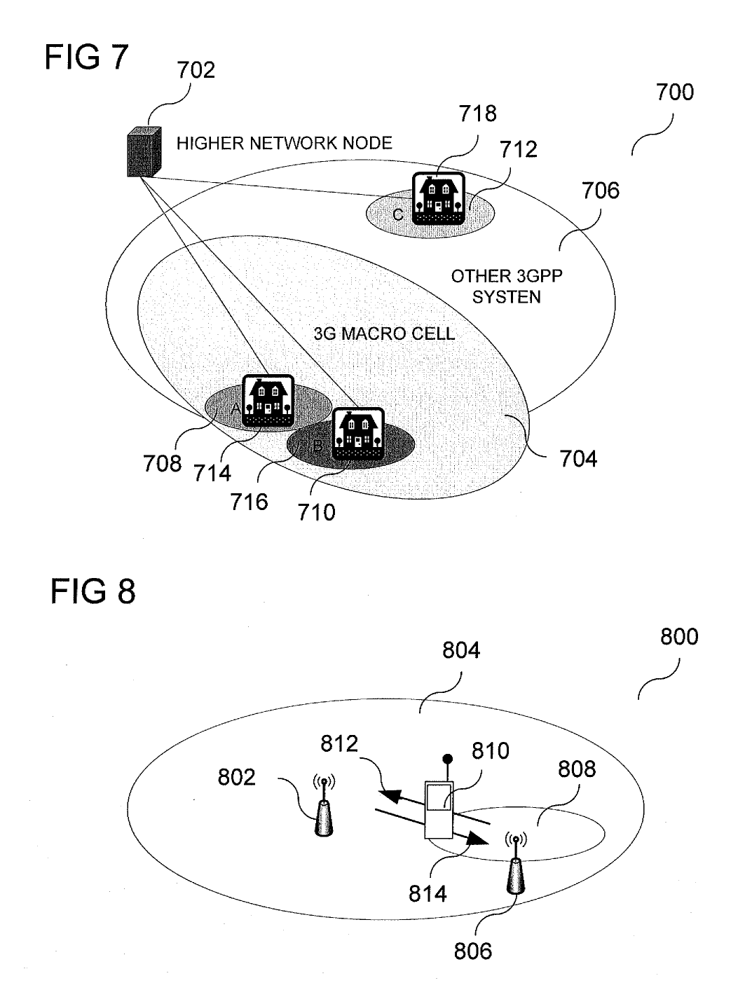

FIG. 7 shows a possible deployment scenario for three Home NodeBs in accordance with an embodiment in an illustration 700.

In this example, a higher network node 702 is shown, which symbolizes all entities of the mobile radio system provided “above” the NodeBs and Home NodeBs. Furthermore, FIG. 7 shows a first mobile radio macro cell 704, provided by a first provider in accordance with a first 3GPP mobile radio communication system, and a second mobile radio macro cell 706, provided by a second provider in accordance with a second 3GPP mobile radio communication system. The first and second providers may be the same provider or different providers. Furthermore, the first and second 3GPP mobile radio communication systems may be the same 3GPP mobile radio communication system or different 3GPP mobile radio communication systems. In an example, the first 3GPP mobile radio communication system may be an LTE mobile radio communication system, and the second 3GPP mobile radio communication system may be a UMTS mobile radio communication system. However, the embodiments are not limited to neither LTE nor UMTS, not even to a 3GPP mobile radio communication system. Any other suitable mobile radio communication system may be used in the context of the described embodiments, e.g. any suitable Licensed Mobile Access mobile radio communication system, such as e.g. a Freedom of Mobile Multimedia Access (FOMA) mobile radio communication system or a Code Division Multiple Access 2000 (CDMA 2000) mobile radio communication system.

As also shown in FIG. 7, in each mobile radio macro cell 704, 706, there may be provided one or more mobile radio micro cells (in the following also referred to as Home NodeB cells) 708, 716, 712, which may be provided by respective Home NodeBs 714, 710, 718. The Home NodeBs 714, 710, 718, may be connected to the respective entities of the higher network node 702 in accordance with the technology provided in the respective mobile radio communication system.

As a ‘Femto Cell’ entity may be a box of small size and physically under control of the user, it may be used nomadically, i.e. the user may decide to operate it in his apartment, but also in a hotel when he is away from home as a business traveler. Additionally a ‘Home Base Station’ may be operated only temporarily, i.e. it may be switched on and off from time to time, e.g. because the user doesn't want to operate it over night or when he leaves his apartment. The operation modes described here represent new challenges to the MNO's core network. The eNodeBs for Macro Cells may be operated permanently at a fix location, and the MNO may allocate a different set of radio resources (e.g., carrier frequencies, time slots and/or codes) to neighboring eNodeBs in his network in order to minimize mutual interference between them.

FIG. 8 shows a possible deployment scenario 800 for one legacy base station 802, for example an (e)NB (Node B or eNodeB) and a home base station 806, for example an H(e)NB (HNB or HeNB) in accordance with an embodiment, and related mobility aspects will be explained with reference to FIG. 8. The legacy base station 802 may provide a macro cell coverage 804. The home base station may provide a femto cell coverage 808. A radio communication device 810, for example an UE, may move from one coverage area to another. In various embodiments, ‘H(e)NB Inbound Mobility’ may be referred to as mobility of a UE 810 from a stationary macro cell 804 to a Femto Cell 808, i.e. from a macro cell coverage 804 to a femto cell coverage 808. ‘H(e)NB Outbound Mobility’ may be referred to as mobility of a UE 810 from a Femto Cell 808 to a stationary macro cell 804, i.e. from a femto cell coverage 808 to a macro cell coverage 804. In FIG. 8, movement of the radio communication device 810 during H(e)NB inbound mobility is indicated by arrow 814, and movement of the radio communication device 810 during H(e)NB outbound mobility is indicated by arrow 812.

In various embodiments, a ‘Home Base Station’ may be allowed for a closed user group only, i.e. the service offering of a particular cell may be restricted to employees of a certain company or family members. The general concept of restricting service offerings of Base Stations may be called ‘Closed Subscriber Group Cells’ (CSG Cells) in accordance with 3GPP terminology. It may not only be applicable to ‘Home Base Stations’, but a Macro Cell may be made a CSG Cell, too.

A cell which indicates being a CSG Cell may desire to provide its CSG Identity to the UEs. Such a cell may only be suitable for a UE if its CSG Identity is in the UE's CSG white list (a list of CSG Identities maintained in the UE or in an associated smart card indicating the cells which a particular UE is allowed to use for communication). The structure of a CSG Identity may include several parts. A CSG Cell may provide its CSG Identity by means of the mobile communication network's system information broadcast capability.

For early CSG Cell detection, the MNO may assign a subset of the PCI value range (PCI-Physical Cell Identifier) to CSG Cells and may advertise this information by means of the mobile communication network's system information broadcast capability, too.

Hybrid Cells (partially open cells) may also be provided.

In the following embodiment an LTE system (E-UTRAN) supporting the concept of Home eNodeBs is considered. It should be mentioned that the embodiments and examples described herein are also applicable in and can easily be adapted to other Radio Access Technologies (RATs), such as UMTS (UTRAN) or GSM (GERAN) in alternative embodiments and examples. In E-UTRAN the eNodeBs are illustratively more intelligent than legacy NodeBs of a UTRAN system, since almost all the RNC functionality has been moved to the eNodeB.

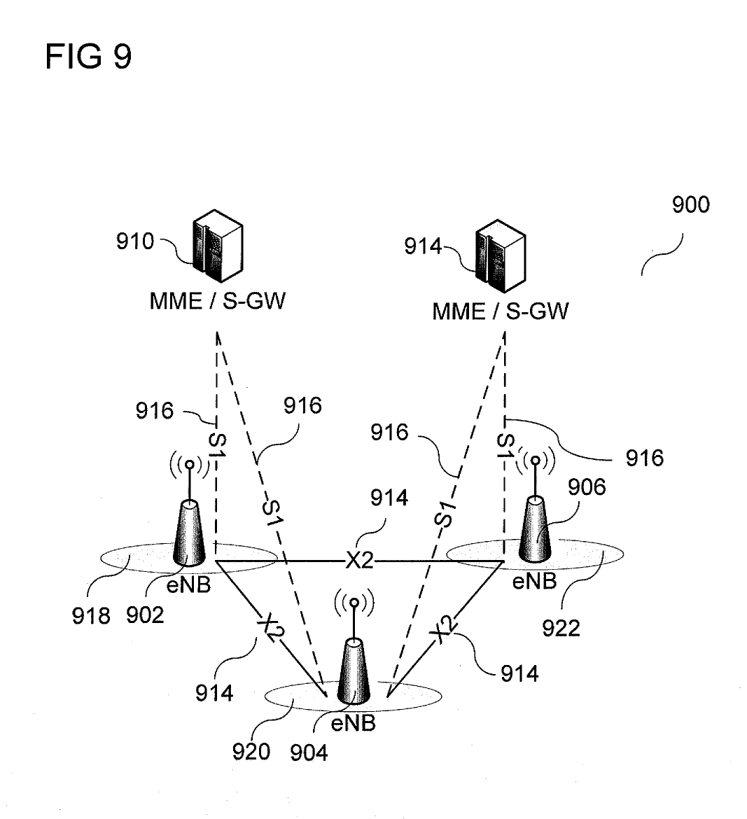

FIG. 9 shows an example E-UTRAN architecture 900 including three eNodeBs 902, 904, 906, two Evolved Packet Cores (EPCs), e.g. a first EPC (not shown), provided by a first operator A (not shown) and including a first MME/S-GW 910, and a second EPC (not shown), provided by a second operator B (not shown) and including a second MME/S-GW 914. In LTE, i.e. according to the LTE architecture, as shown in the Logical E-UTRAN Architecture as defined by 3GPP shown in FIG. 9, the eNodeBs 902, 904, 906, may be interconnected with each other by means of the X2 interfaces 914. Furthermore eNodeBs 902, 904, 906, may be connected by means of the S1 interfaces 916 to the MME/S-GW 910, 914, of the respective first EPC and second EPC. The S1 interface 916 as defined by 3GPP may support a many-to-many relation between the first and second EPC, and eNodeB 902, 904, 906, i.e. theoretically different operators may simultaneously operate the same eNodeB 902, 904, 906. The eNodeBs 902, 904, 906, may provide mobile radio coverage for the radio communication terminal device located in the respective mobile radio cells 918, 920, 922.

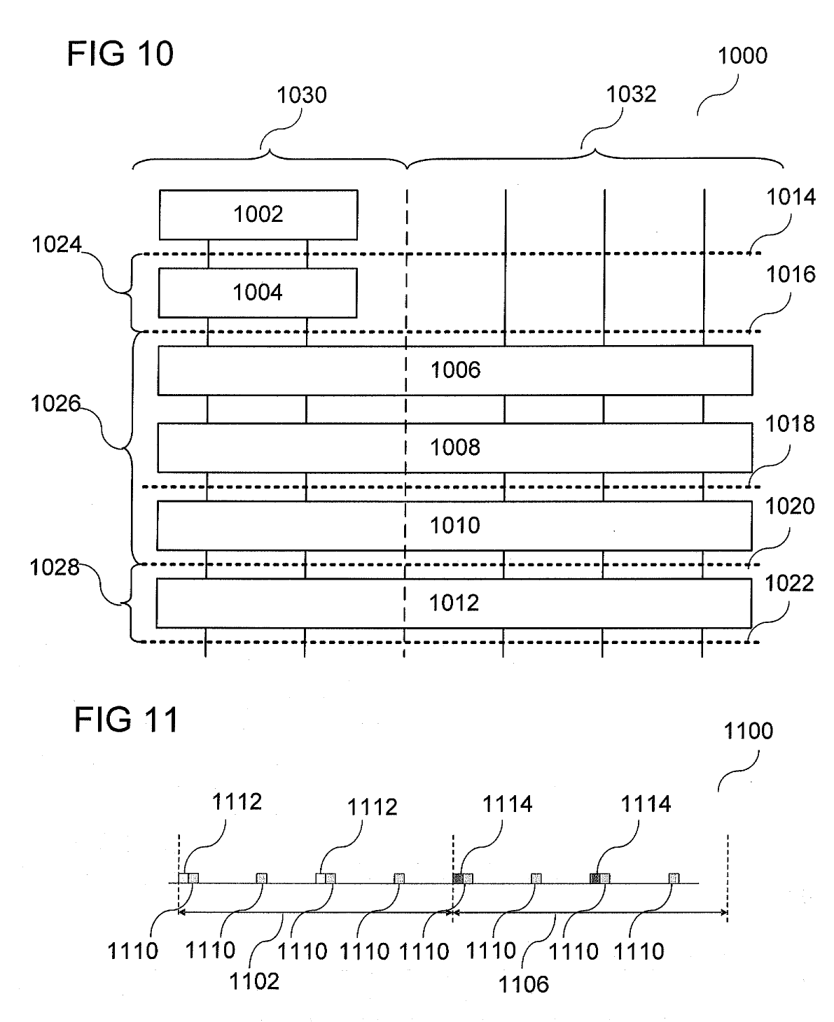

FIG. 10 shows a protocol stack 1000 of the 3GPP LTE (Long Term Evolution) system in accordance with an embodiment. Below the non-access stratum (NAS) 1002, Layer 3 (1024) including the Radio Resource Control (RRC) sublayer 1004 may be provided.

The protocol stack overview 1000 for the 3GPP LTE system may be split into the C-Plane 1030 and the U-Plane 1032.

A Layer 2 (1026) of the protocol stack 1000 may be split into the following sublayers: Medium Access Control (MAC) 1010, Radio Link Control (RLC) 508 and Packet Data Convergence Protocol (PDCP) 1006.

The Service Access Points (SAPs) between the physical layer 1012 included in Layer 1 (1028) and the MAC sublayer 1010 may provide the transport channels 1020. The SAPs between the MAC sublayer 1010 and the RLC sublayer 1008 may provide the logical channels 1018. The SAPs between the PDCP sublayer 1006 and the RRC sublayer 1004 may provide the radio bearers 1016. The SAPs between the RRC sublayer 1004 and the NAS 1002 may provide the SAE bearers (System Architecture Evolution) 1014. The SAPs below the physical layer 1012 may provide the physical channels 1022. The multiplexing of several logical channels (e.g. radio bearers) on the same transport channel (e.g. transport block) may be performed by the MAC sublayer 1010. In both uplink and downlink, only one transport block may be generated per TTI (Transmission Time Interval) in the non-MIMO case.

In an embodiment, the RRC protocol layer 1004 making up the C-Plane (control plane) 1030 of the system may be of particular relevance. The main services and functions of the RRC sublayer 1004 may include:
Broadcast of System Information related to the non-access stratum (NAS);
Broadcast of System Information related to the access stratum (AS);
Paging;
Establishment, modification and release of an RRC connection between the UE and E-UTRAN including: Allocation of temporary identifiers between UE and E-UTRAN; Configuration of signaling radio bearer(s) (SRB) for RRC connection: Low priority SRB and high priority SRB;
Security functions including key management;
Establishment, configuration, maintenance and release of point to point Radio Bearers;
Mobility functions including: UE measurement reporting and control of the reporting for inter-cell and inter-RAT mobility; Inter-cell handover; UE cell selection and reselection and control of cell selection and reselection; Context transfer between eNBs;
QoS management functions;
UE measurement reporting and control of the reporting; and
NAS direct message transfer to/from NAS from/to UE.

Concerning system information acquisition, the RRC sublayer 1004 may be used to broadcast System Information in the downlink. Generally speaking System Information (SI) may be an RRC message carrying a number of System-Information-Blocks (SIBs) that may have the same scheduling requirements (i.e. periodicity). There may be more than one System Information (SI) RRC message transmitted with the same periodicity.

Each SIB may contain a set of related system information parameters. Several SIBs may be provided in accordance with 3GPP including the Master-Information-Block (MIB), that may include a limited number of most frequently transmitted parameters, and SIB Type 1 may contain the scheduling information that mainly may indicate when the other System Information (SI) RRC messages are transmitted, i.e. their start times.

SYSTEM INFORMATION MASTER (SI-M) and SYSTEM INFORMATION 1 (SI-1) may be special versions of a System Information (SI) RRC message only carrying a single SIB, namely the MIB and the SIB Type 1 respectively. The SI-M message may be carried on BCH (Broadcast Channel, one of the downlink transport channel) while all other System Information (SI) RRC messages including SI-1 may be carried on DL-SCH (Downlink Shared Channel, another one of the downlink transport channels).

Both the SI-M and SI-1 may use a fixed schedule with a periodicity of 40 and 80 ms respectively. The first transmission of the SI-M may be scheduled in radio frames for which the SFN mod 4=0. SI-1 may be scheduled in radio frames for which the SFN mod 8=0. Moreover, SI-1 may be scheduled in sub-frame #5.

The scheduling of System Information (SI) RRC message other than SI-M and SI-1 may be flexible, i.e. dynamic scheduling may be used: the UE may acquire the detailed time-domain and frequency domain scheduling (as well as other information, such as the transport format used) of these System Information (SI) RRC messages from the PDCCH (Physical Downlink Control Channel). It may be possible that the PDCCH does not indicate which System Information (SI) RRC message is scheduled, i.e. a single SI-RNTI (System Information Radio Network Temporary Identifier) may be used for all different types of System Information (SI) RRC messages.

Each System Information (SI) RRC message may be transmitted in a periodically occurring (time domain) window, having a defined semi-static starting point and length. The SI-windows may be non-overlapping and the size of all SI-windows may be the same. SI-1 may configure the SI-window length and the transmission periodicity for the other System Information (SI) RRC messages.

A SIB may not be spread over multiple consecutive System Information (SI) RRC messages, but—as far as the SIB Types 2-11 are concerned—one System Information (SI) RRC message may include multiple SIBs (if those have the same periodicity). The mapping of SIBs onto System Information (SI) RRC messages may be flexible; it may be configured in the SI-1 message. Table 1 gives an overview of the different types of System Information (SI) RRC messages.

TABLE 1
System Information Overview

| System Information | | | | First | |
|---|---|---|---|---|---|
| RRC Message | Content | Purpose | Periodicity | Transmission | Repetitions |
| SI-M | One MIB | most essential | fixed, | in subframe | in subframe |
| | | physical layer info of | 40 ms | #0 of radio | #0 of all |
| | | the cell desired to | | frame for | other radio |
| | | receive further | | which the | frames |
| | | system info | | SFNmod4 = 0 | |
| SI-1 | one SIB | info relevant to cell | fixed, | in subframe | in subframe |
| | Type 1 | access and scheduling | 80 ms | #5 of radio | #5 of all |
| | | of other SIBs | | frame for | other radio |
| | | | | which the | frames for |
| | | | | SFNmod8 = 0 | which |
| | | | | | SFNmod2 = 0 |

| | | | | |
|---|---|---|---|---|
| SI | multiple | various purposes | flexible | in dynamically scheduled SI |
| | SIBs | depending | | window; UE may acquire |
| | (Type 2- | on SIB Type | | details about scheduling from |
| | 11) | | | decoding SI-RNTI on |
| | | | | PDCCH |

System information changes may only occur at specific radio frames i.e. the concept of a modification period may be used. System Information (SI) RRC messages may be transmitted a number of times with the same content within a modification period, as defined by its scheduling. The modification period boundaries may be defined by SFN mod N. N may be configured by system information.

FIG. 11 shows a diagram 1100 illustrating a change of system information in accordance with an embodiment. For the example shown in FIG. 11, the blocks 1110 indicate the frame periodicity (N=4 in the example in FIG. 11). The blocks 1112 indicate old system information and the blocks 1114 indicate new system information. The n-th BCCH (Broadcast Control Channel) modification period 1102 may be used to transmit change notification. The (n+1)-th BCCH modification period 1106 may be used to transmit updated information.

When the network changes (some of the) system information, it first may notify the UEs about this change i.e. this may be carried out throughout a modification period. In the next modification period, the network may transmit the updated system information.

Upon receiving a change notification, the UE may know that the current system information is valid until the next modification period boundary. After this boundary, the UE may acquire the new system information. There may be a (short) period during which the UE may not have valid system information.

For a UE in RRC_IDLE the PAGING message may be used to inform it about a system information change. UEs in RRC_CONNECTED may desire to monitor the PDCCH at a periodic occasion specifically defined for this purpose i.e. a ‘Connected mode system information change notification’ occasion. If the UE detects the System-Information-Change-RNTI (SC-RNTI) on PDCCH, it may know that the system information changes at the next modification period boundary. Although the UE may be informed about changes in system information, no further details may be provided e.g. regarding which System Information (SI) RRC message has changed. It is possible to not use the change notification mechanism for those system information using an expiry timer (intended for the more dynamic system information).

The SI-1 message may include a value tag that may indicate if a change has occurred in system information other than the SI-M and SI-1. UEs may use this value tag e.g. upon return from out of coverage, to verify if the previously acquired system information is still valid. The UE may consider system information to be valid for at most a pre-defined period of time, for example for at most 6 hours from the moment it was received.

In accordance with 3GPP, a MasterInformationBlock which may inform the UE about the most essential physical layer parameters of the mobile radio cell that are desired by a UE to receive further system information may be defined in various embodiments. MIB Details of some physical layer parameters which may be provided in various embodiments may be:
dl-SystemBandwidth, which may be of a type ENUMERATED {n6, n15, n25, n50, n75, n1001, wherein n6, n15, n25, n50, n75, n100 may represent different values;
phich-Config (which may be of a type PHICH-Config);
systemFrameNumber (which may be of a type BIT STRING (SIZE (8))); and
spare (which may be of a type BIT STRING (SIZE (10))).

Additionally, in 3GPP a SystemInformationBlock1 that may contain information relevant when evaluating if a UE is allowed to access a cell and defines the scheduling of other System Information Blocks (SIBs) is defined. Currently the list of information elements in this container includes the items shown in Table 2, which gives SIB-Type1 Details.

TABLE 2
Information Elements included in SystemInformationBlock1

| | |
|---|---|
| cellAccessRelatedInformation | SEQUENCE |

| | |
|---|---|
| plmn-IdentityList | SEQUENCE (1..6) |

| | |
|---|---|
| plmn-Identity | PLMN Identity |
| cellReservedForOperatorUse | ENUMERATED {reserved, notReserved} |

| | |
|---|---|
| trackingAreaCode | Tracking Area Code |
| cellIdentity | Cell Identity |
| cellBarred | ENUMERATED {barred, notBarred} |
| intraFrequencyReselection | ENUMERATED {allowed, notAllowed} |
| csg-Indication | BOOLEAN |
| csg-Identify | BIT STRING (SIZE (27)) |

| | |
|---|---|
| cellSelectionInfo | SEQUENCE |

| | |
|---|---|
| q-Rxlevmin | Q-RxLevMin |
| q-Rxlevminoffset | INTEGER (1..8) |

| | |
|---|---|
| p-Max | P-Max |
| frequencyBandIndicator | INTEGER (1..64), |
| schedulingInfoList | SEQUENCE (1..maxSI-Message) |

| si-Periodicity | ENUMERATED{rf8,rf16,rf32,rf64,rf128,rf256, |
|---|---|
| | rf512}, |
| sib-MappingInfo | SEQUENCE (1..maxSIB) OF SIB-Type |

| | |
|---|---|
| tdd-Config | TDD-Config |
| si-WindowLength | ENUMERATED (ms1,ms2,ms5,ms10,ms20,ms40) |
| systemInformationValueTag | INTEGER (0..31) |

In 3GPP further SystemInformationBlocks for various purposes may be defined. These may be referred to as SIB Types 2-11 in 3GPP. Each of them may contain a number of different Information Elements (IE). Some of those other SIB Types are shortly referred to in the following.

SIB-Type2 may contain common and shared channel information.

SIB-Type3 may contain cell re-selection information, mainly related to the serving cell.

SIB-Type4 may contain information about the serving frequency and intra-frequency neighboring cells relevant for cell re-selection. This may includes cell re-selection parameters common for a frequency as well as cell specific re-selection parameters.

SIB-Type5 may contain information about other E-UTRA frequencies and inter-frequency neighboring cells relevant for cell re-selection. This may includes cell re-selection parameters common for a frequency as well as cell specific re-selection parameters.

SIB-Type6 may contain information about UTRA frequencies and UTRA neighboring cells relevant for cell re-selection. This may include cell re-selection parameters common for a frequency as well as cell specific re-selection parameters.

SIB-Type7 may contain information about GERAN frequencies relevant for cell re-selection. This may include cell re-selection parameters for each frequency.

SIB-Type8 may contain information about CDMA2000 frequencies and CDMA2000 neighboring cells relevant for cell re-selection. This may include cell re-selection parameters common for a frequency as well as cell specific re-selection parameters.

SIB-Type9 may contain a Home eNodeB identifier (HNBID) coded in UTF-8 with variable number of bytes per character to allow the owner of a Home Base Station to submit his own text over the air (for example ‘Griswold Family’).

SIB-Type10 may contain an ETWS (Earthquake and Tsunami Warning System) primary notification.

SIB-Type11 may contain an ETWS secondary notification.

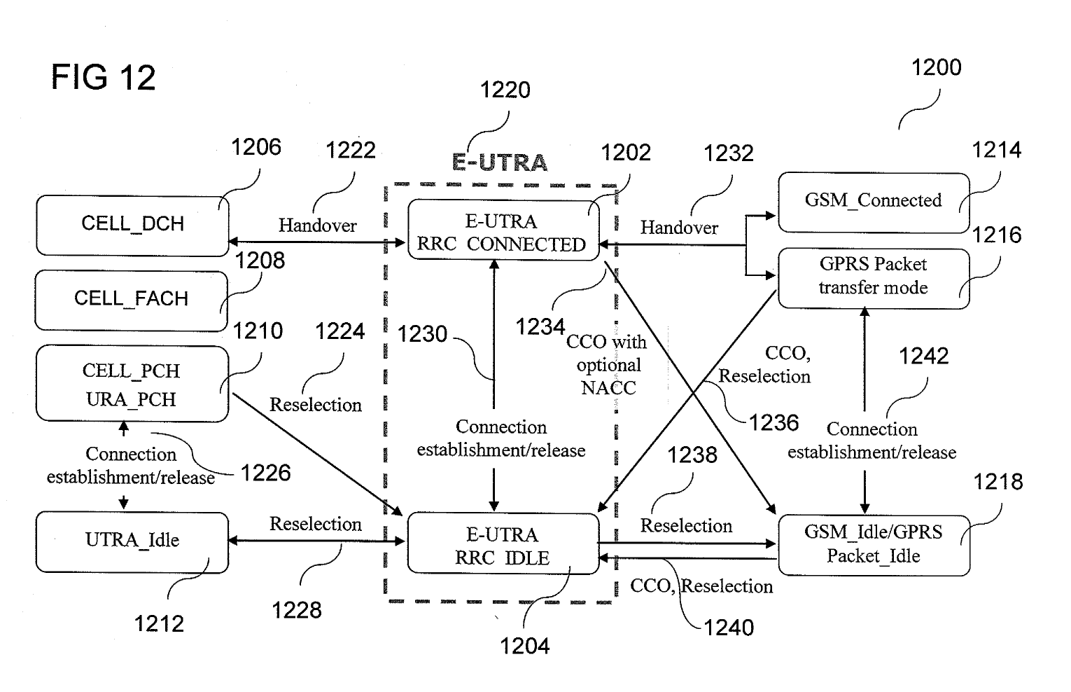

FIG. 12 shows an overview 1200 of the two E-UTRA RRC States E-UTRA RRC CONNECTED 1202 and E-UTRA RRC IDLE 1204, and also illustrates the inter-RAT mobility support between E-UTRA 1200 (3.9G LTE, the two states depicted in the centre of FIG. 12), UTRA (3G UMTS, left part of the FIG. 12) and GERAN (2G and 2.5G, right part of FIG. 12).

As shown in FIG. 12, it may be switched between the state of E_UTRA RRC CONNECTED 1202 and the state of E_UTRA RRC IDLE 1204 by connection establishment/release as indicated by arrow 1230. A switch between CELL_DCH state 1206 and E-UTRA RRC CONNECTED state 1202 may be performed by a handover, as indicated by arrow 1222. In UMTS, a CELL_FACH state 1208 may be provided. Furthermore, a switch between a CELL_PCH resp. URA_PCH state 1210 and an UTRA Idle state 1212 may be performed by connection establishment/release as indicated by arrow 1226. A switch from a CELL_PCH resp. URA_PCH state 1210 to an E-UTRA RRC IDLE state 1204 may be performed by reselection, as indicated by arrow 1224. A switch between UTRA Idle state 1212 and an E-UTRA RRC IDLE state 1204 may be performed by reselection, as indicated by arrow 1228. A switch between an E-UTRA RRC CONNECTED state 1202 and a GSM_Connected state 1214 resp. GPRS Packet transfer mode 1216 may be performed by handover, as indicated by arrow 1232. A switch from an E-UTRA RRC CONNECTED state 1202 to a GSM_Idle/GPRS Packet_Idle state 1218 may be performed by CCO (Cell Change Order) with optional NACC (Network Assisted Cell Change), as indicated by arrow 1234. A switch from a GPRS Packet transfer mode 1216 to an E-UTRA RRC IDLE state 1204 may be performed by CCO resp. reselection, as indicated by arrow 1236. A switch between a GPRS packet transfer mode 1216 and a GSM_Idle/GPRS Packet_Idle state 1218 may be performed by connection establishment/release, as indicated by arrow 1242. A switch from an E-UTRA RRC IDLE mode 1204 to a GSM_Idle/GPRS Packet_Idle state 1218 may be performed by reselection, as indicated by arrow 1238. A switch from a GSM_Idle/GPRS Packet_Idle state 1218 to an E-UTRA RRC IDLE mode 1204 may be performed by CCO resp. reselection, as indicated by arrow 1240.

In various embodiments, the two distinct UE states in LTE (E-UTRA) may be RRC IDLE and RRC CONNECTED.

In various embodiments, in RRC IDLE, mobility may be UE controlled.

In various embodiments, in RRC IDLE, a UE specific discontinuous reception (DRX) may be configured by upper layers.

In various embodiments, in RRC IDLE, the UE may acquire system information (SI).

In various embodiments, in RRC IDLE, the UE may monitor a paging channel to detect incoming calls, system information change, and for ETWS capable UEs, ETWS notifications.

In various embodiments, in RRC IDLE, the UE may performs neighboring cell measurements for the cell (re-)selection process.

In various embodiments, a UE may be in RRC_CONNECTED, when an RRC connection has been established.

In various embodiments, in RRC_CONNECTED, mobility may be controlled by the network (handover and cell change order).

In various embodiments, in RRC_CONNECTED, data may be transferred to/from UE.

In various embodiments, in RRC_CONNECTED, at lower layers, the UE may be configured with a UE specific discontinuous reception (DRX).

In various embodiments, in RRC_CONNECTED, the UE may acquire system information (SI).

In various embodiments, in RRC_CONNECTED, the UE may monitor a paging channel and/or SIB Type 1 content to detect SI change, and for ETWS capable UEs, ETWS notifications.

In various embodiments, in RRC_CONNECTED, the UE may monitor the control channels associated with the shared data channel to determine if data is scheduled for it.

In various embodiments, in RRC_CONNECTED, the UE may provide channel quality and feedback information.

In various embodiments, in RRC_CONNECTED, the UE may perform neighboring cell measurements and reporting to assist the network in making handover decisions.

In various embodiments, a Cell Reselection Preparation Process may be applicable to UEs that reside in RRC_IDLE state as shown in FIG. 12. During Cell Reselection Preparation Process the UE may go through a number of process steps including

PSC (Primary Scrambling Code)/PCI (Physical Cell Identifier) search; synchronization;

SI acquisition;

performing measurements (according to some basic instructions received with SI);

If certain criteria are met (e.g., cell is not barred, measurements indicate good signal strength, etc.) the UE itself may decide to do cell reselection.

As indicated above, the UE's mobility may be controlled by the UE itself. If the UE finds a cell that is better suited, it may choose to camp on this better suited cell. If the UE finds from the new cell's SI that the Tracking Area Code has not changed, it may remain in RRC_IDLE state. Otherwise, the UE may establish an RRC connection in the new cell to inform the network about a change of its tracking area.

In various embodiments, the Handover Preparation Process may only apply to UEs that reside in RRC_CONNECTED state as shown in FIG. 12. During this process a UE may go through a number of process steps including:
PSC/PCI search;
synchronization;
SI acquisition;
performing measurements (according to a detailed RRC Measurement Configuration); and
do measurement reporting (by means of a dedicated RRC Message as configured by RRC).

In various embodiments, a UE in RRC_CONNECTED may measure and report on its current serving cell, all listed cells (as listed in the Neighbor Cell List) and all ‘detected’ cells. In various embodiments of H(e)NB deployment scenarios, the number of ‘detected’ Femto Cells may be high.

If certain criteria are met (e.g., cell is not barred, measurements indicate good signal strength, etc.) the UE may be triggered by the network to perform handover from its current serving cell to a new target cell.

As indicated above, the UE's mobility may be controlled by the network, which will send out a handover command to the UE if certain measurements reported by the UE meet certain criteria.

Both procedures presented here, Cell Reselection Preparation (for UEs in RRC_IDLE) and Handover Preparation (for UEs in RRC_CONNECTED), have in common that they may be aiming at finding out details about better suited cells in a UE's current radio environment. The principles may be the same regardless of whether intra-frequency or inter-frequency or inter-RAT case is considered.

In various embodiments, methods may be provided for supporting a UE to find an appropriate cell in a deployment scenario with macro cells and CSG Cells, especially when there is a dense deployment of CSG Cells. The term “appropriate” in this context means a ‘suitable cell’ as defined in 3GPP, e.g. a cell on which a UE may camp.

In various embodiments, H(e)NBs may be configured as CSG Cells.

In various embodiments, for some mobile network operators (MNOs), inbound handover to CSG Cells may not be desired in all deployment or business scenarios. If such a handover is not desired, it may be useless for a UE in RRC_CONNECTED to look out for H(e)NBs that are configured as CSG Cells, because this process may consume energy, may occupy resources, and may result in unnecessary signaling load on the network side. It may still make sense though for a UE to look out for other macro cells.

Even if inbound handover to CSG Cells may be generally supported, a problem may arise from the UE's obligation to measure and report on all ‘detected’ cells (in addition to its current serving cell and the cells given in the Neighbor Cell List). In most H(e)NB deployment scenarios the number of ‘detected’ Femto Cells may be quite high and to perform measurements and report on all of these cells may be an extra burden on the UE. So it may be desirable to restrict the list of ‘detected’ cells a UE is obliged to measure and report on by some filtering criteria.

In various embodiments, outbound mobility from H(e)NBs that are configured as CSG Cells may also require some attention in this respect, as there may be two types of macro cells available for a UE that is about to leave coverage of a CSG Cell: macro cells that support a potential future handover of the UE back to the CSG Cell and macro cells that don't offer this support. For a UE in RRC_IDLE that is leaving coverage of a CSG Cell and desires to make a decision what macro cell to camp on, knowledge of handover support details of its new macro cell may be desirable. If the UE has no knowledge about the available macro cells' handover capabilities, it might select a macro cell that does not support handover back to the CSG Cell at a later point in time (when the UE is possibly in RRC_CONNECTED); it might simply pick the strongest macro cell instead.

In various embodiments, a macro cell's Handover Support Information (or Handover Restriction Information when looking at it from a different angle) may be signaled to all or selected UEs in its coverage, i.e. an indication whether Handover to CSG Cells is allowed (or ‘supported’) or disallowed (or ‘not supported’). In various embodiments, the signaling may be done for example

1) in broadcast mode via the macro cells' system information (SI) to all UEs, including
UEs in RRC_IDLE that are looking out for better suited cells (i.e. UEs that are camping on a cell different from the macro cell that is sending out the respective set of data),
UEs in RRC_IDLE camping on the respective macro cell, and
UEs in RRC_CONNECTED in that macro cell.

2) via RRC signaling on a Common Control Channel (broadcast to all UEs in RRC_CONNECTED); and

3) via RRC signaling on Dedicated Control Channels (transfer to selected UEs in RRC_CONNECTED).
UEs in RRC_IDLE may use this information to decide whether the corresponding cell is worth to be monitored (i.e. if the monitored cell can be taken into account as a candidate for an imminent Cell Reselection). UEs in RRC_CONNECTED may use this information to restrict the list of ‘detected cells’ that need to be measured and reported on, when inbound handover to CSG Cells is not desired according to mobile network operator's policy.

In accordance with various embodiments, the network may configure inbound handover into CSG Cells different from ‘normal’ handover. In accordance with various embodiments, new deployment scenarios, and business scenarios may be enabled for the mobile network operator (MNO) community.

In accordance with various embodiments, in the UE battery drain caused by unnecessary measurements, and measurement reporting may be reduced.

In accordance with various embodiments, energy consumption by performing PSC/PCI search, synchronization or SI acquisition may be restricted to a minimum.

In accordance with various embodiments, some or all UE resources that are involved in the Cell Reselection Preparation Process and Handover Preparation Process may be freed and may be used to enhance the performance of other UE activities.

In accordance with various embodiments, unnecessary signaling load on the network side may be avoided.

In various embodiments, Handover Support Information (or Handover Restriction Information when looking at it from a different angle) may be indicated from macro cells to dedicated UEs or to all UEs.

In various embodiments, in a deployment scenario where inbound handover to CSG Cells is not allowed by the mobile network operator (MNO), an indication may be transferred from the network to the UE aiming at informing the UE that inbound handover to CSG Cells from this particular macro cell is generally not allowed. As explained above, without such indication, a UE in RRC_CONNECTED in a macro cell would measure and report on all CSG cells found, although it may have no chance to ever use them. It may simply not know that an inbound handover to these CSG Cells will never occur. Also, without such indication, a UE in RRC_IDLE that is about to leave a CSG Cell would have no knowledge of whether the macro cell it is about to camp on will support inbound handover back to CSG Cells (should this handover become necessary in future).

In various embodiments, for the deployment scenario where inbound handover to CSG Cells is allowed, some filtering criteria may be transferred from the network to the UE aiming at restricting the list of ‘detected’ cells a UE is obliged to measure and report on. As explained above, measuring and reporting on all ‘detected’ cells in accordance with 3GPP may be a burden on the UE.

In the following, the term Early Handover Support Indication (EHSI) will be used. In one embodiment, the EHSI may be a simple flag consisting of a Header Name and a corresponding Field Value. In another embodiment, the EHSI may be more sophisticated (e.g. made up of a data container) and may include more than just one pair of Header Name and Field Value. Within the data container several headers and/or values may depend on the presence and/or value of each other.

It should be noted that the term Early Handover Support Indication (EHSI) may also be interpreted as handover restriction information when looking at it from a different angle. Thus, the flag or the data container may include information expressing restrictions pertaining to UE mobility in addition to or instead of mobility support information.

In various embodiments, the EHSI may be broadcast via the macro cells' System Information (SI).

In various embodiments, the EHSI may be a single flag signaling something like “Inbound handover from this cell to CSG Cells is (not) supported”. Such kind of information may be encoded very efficiently, so the EHSI in this embodiment may be placed in SIB-Type1 where information relevant to evaluating if a UE is allowed to access a cell and to the scheduling of the other System Information Blocks (SIBs) may be given.

In an embodiment, the EHSI may carry the Header Name HandoverSupportToCSGCells (cf. the box highlighted in Table 3 of the enhanced SIB-Type1 below) and may be set either to true (=support) or false (=no support). In other words the type of the field value may be boolean.

The new list of information elements in SIB-Type1 may be as shown in Table 3.

TABLE 3
New list of Information Elements included in SystemInformationBlock1 in
accordance with various embodiments

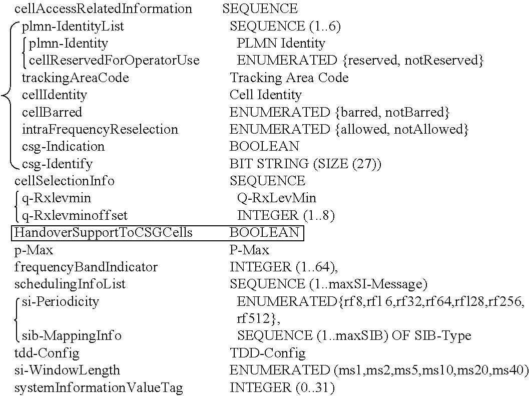

In various embodiments, the new flag may be placed in one of the other SIBs, for instance in SIB-Type3 which may contain cell re-selection information (for example related to the serving cell).

In various embodiments, as SIB-Type1 may be read and evaluated earlier than the other SIBs, in case the information is included in SIB-Type1, the information may be signaled to the UE as early as possible.

In accordance with various embodiments, by signaling the EHSI via the macro cells' System Information (SI) in broadcast mode as explained above, UEs in the following states may be informed efficiently in terms of bandwidth:
UEs in RRC_IDLE that are looking out for better suited cells;
UEs camping on a cell different from the macro cell that is sending out this EHSI;
UEs camping on the respective macro cell that is sending out this EHSI; and
UEs in RRC_CONNECTED in that macro cell.

In various embodiments, if the EHSI Flag includes the example configuration HandoverSupportToCSGCells=False (or ‘NoSupport’), the UE may be not required to measure and report on any of the detected CSG Cells in its current radio environment. The UE may save energy and may not waste processing power.

In various embodiments, if the EHSI Flag includes the example configuration HandoverSupportToCSGCells=True (or ‘Support’), the UE may expect some sophisticated measurement configuration (pertaining to measuring and measurement reporting on CSG Cells) when in RRC_CONNECTED.

In various embodiments, if the entire EHSI Flag is missing from the corresponding SIB, normal UE behavior according, like it is commonly done, may be expected.

In various embodiments, the field value of the HandoverSupportToCSGCells parameter may be encoded for instance as:

HandoverSupportToCSGCells ENUMERATED {supportedInPrinciple, Supported, notSupported}.

In various embodiments, a UE that receives an EHSI with a Field Value set to ‘supportedInPrinciple’ may know that Inbound Handover from this cell to CSG Cells is supported in principle, but may somehow be restricted. In other words: The EHSI in this embodiment may serve as a reference pointing the UE to a new type of measurement configuration (for measuring and measurement reporting on CSG Cells), as will be described in detail below.

In various embodiments, the EHSI may be signaled via RRC on a Dedicated Control Channel.

In various embodiments, once an RRC connection has been established, signaling data may be exchanged between the network and the UE (and vice versa) in many different ways. In accordance with an embodiment, control plane data may be conveyed over the so-called Dedicated Control Channel (DCCH) in downlink (DL). The DL-DCCH-Message class may be the set of RRC Messages that may be sent from the E-UTRAN to the UE on the downlink DCCH logical channel.

In various embodiments, the RRCConnectionReconfiguration RRC Message may be the command to modify an RRC connection. It may also be used to convey information for measurement configuration and mobility control to the UE. In various embodiments, the relevant portion of this RRC Message may be the measConfig Information Element in accordance with 3GPP. The MeasConfig Information Element may specify measurements to be performed by the UE, and may cover intra-frequency, inter-frequency and inter-RAT mobility as well as configuration of measurement gaps.

In various embodiments, two variants may exist for embodiments in RRC_CONNECTED, as will be explained below.

In various embodiments, some filtering criteria may be transferred from the network to the UE aiming at restricting the list of ‘detected’ cells a UE is obliged to measure and report on. These embodiments may be applied to a dense Femto Cell scenario like described above where the mobile network operator may allow inbound handover to CSG Cells in general. In accordance with various embodiments, the EHSI may be a data container consisting of several Header Names and Field Values. It may be added to the MeasConfig Information Element and may be conveyed to the UE as part of the RRCConnectionReconfiguration RRC Message.

In accordance with various embodiments, the enhanced MeasConfig Information Element may be configured as shown in Table 4.

TABLE 4
Enhanced MeasConfig Information Element in accordance with various embodiments

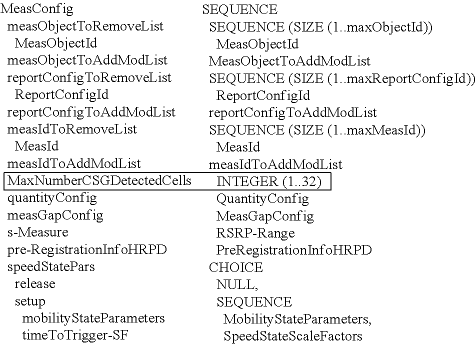

In accordance with various embodiments, with enhanced MeasConfig Information Element, a UE may be informed to restrict both the number of measurements and measurement reporting on detected CSG cells (Header Name MaxNumberCSGDetectedCells, cf. the box highlighted in the enhanced MeasConfig Information Element shown in Table 4 above). If—for example—the Field Value of the MaxNumberCSGDetectedCells is set to ‘3’, the UE may be desired to only measure and report on three detected CSG Cells. In accordance with various embodiments, this may reduce the UE's burden.

In various embodiments, a more sophisticated approach may be provided. In an embodiment, the UE may be configured in more detail to measure on all detected cells, including CSG cells, but to only report a subset of the cells measured. In various embodiments, the list of reported cells may for instance be compiled based on

1) the type of cell (e.g. based on the PCI range distinguishing fully open cells from CSG Cells);

2) signal strength compared against thresholds;

3) Reference Signal Received Power (RSRP);

4) Reference Signal Received Quality (RSRQ);

5) pre-defined leaving/entering conditions like the events A2 through A5 (for intra frequency) or B1 through B2 (for inter RAT) as defined in accordance with 3GPP;

6) special hysteresis for measurements on Femto Cells.

In accordance with various embodiments, the sophisticated enhancements for the MeasConfig Information Element may be configured as shown in Table 5.

TABLE 5
Enhanced MeasConfig Information Element in accordance with various embodiments

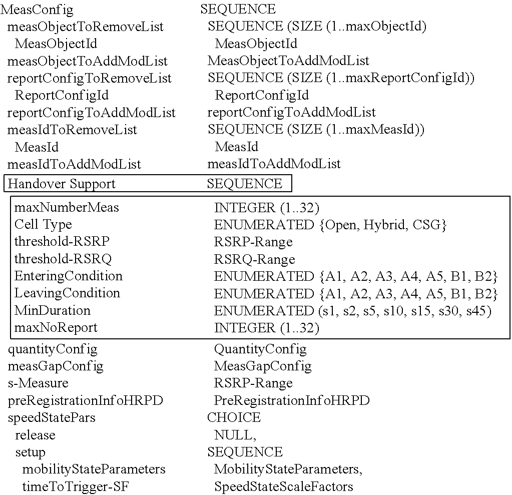

For example, if the Handover Support data container in the enhanced MeasConfig Information Element includes the following example configuration in accordance with various embodiments:
maxNumberMeas=5;
CellType=CSG;
threshold-RSRP=50 (for example according to mapping table in accordance with 3GPP);
threshold-RSRQ=17 (for example according to mapping table in accordance with 3GPP);
LeavingCondition=A2 (serving cell becomes worse than threshold);
MinDuration=s5;
maxNoReport=2;

the UE may be desired to measure on no more than five detected CSG cells (instead of all detected cells found), as soon as the serving cell becomes worse than the thresholds given. The reporting range of RSRP in accordance with 3GPP may be defined from −140 dBm to −44 dBm with 1 dB resolution. The reporting range of RSRQ in accordance with 3GPP may be defined from −19.5 dB to −3 with 0.5 dB resolution. In this example, out of these five cells measured only 2 shall be reported by the UE to the network, if the conditions remain stable for at least five seconds (which is indicated by “s5” as the value for MinDuration).

In various embodiments, the UE may send back its measurement results by means of the MeasurementReport RRC Message.

In various embodiments, the EHSI may be signaled via RRC on a Common Control Channel.

In accordance with various embodiments, once an RRC connection has been established, signaling data may be exchanged between the network and the UE (and vice versa) in many different ways. In various embodiments, control plane data may be conveyed over the so-called Common Control Channel (CCCH) in downlink (DL). The DL-CCCH-Message class may be the set of RRC Messages that may be sent from the E-UTRAN to all UEs on the downlink CCCH logical channel. Subsets of UEs may be addressed by using a certain RNTI (radio network temporary identifier) in the RRC Message. In various embodiments, the downlink CCCH logical channel may be used to signal the EHSI from the network to the UEs in an RRC Message using a Broadcast-RNTI for this purpose.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A radio base station comprising:
a message generator configured to generate a message comprising information specifying whether the radio base station is a radio base station which allows handover to another radio base station.

2. The radio base station of claim 1,
wherein the message generator is further configured to generate a message comprising information specifying whether the radio base station is a radio base station which allows handover to another radio base station of a pre-defined type.

3. The radio base station of claim 2,
wherein the pre-defined type is a type of radio base station that allows connection only to one or more pre-defined radio communication devices.

4. The radio base station of claim 1, further comprising:
a message transmitter configured to transmit a message generated by the message generator.

5. The radio base station of claim 4,
wherein the message transmitter is further configured to broadcast the message.

6. The radio base station of claim 4,
wherein the message transmitter is further configured to transmit the message via a System Information Message of the radio base station.

7. The radio base station of claim 5,
wherein the message transmitter is further configured to transmit the message on a common control channel.

8. The radio base station of claim 1,
wherein the message generated by the message generator further comprises at least one information selected from a group of information consisting of:
a maximum number of radio base stations a radio communication device shall measure for at least one of the preparation of handover and the preparation of cell re-selection;
a maximum number of radio base stations a radio communication device shall report measurement results on for at least one of the preparation of handover and the preparation of cell re-selection;
a maximum number of radio base stations of a pre-defined type a radio communication device shall measure for at least one of the preparation of handover and the preparation of cell re-selection;
a maximum number of radio base stations of a pre-defined type a radio communication device shall report measurement results on for at least one of the preparation of handover and the preparation of cell re-selection;
a maximum number of closed subscriber group radio base stations a radio communication device shall measure for at least one of the preparation of handover and the preparation of cell re-selection;
a maximum number of closed subscriber group radio base stations a radio communication device shall report measurement results on for at least one of the preparation of handover and the preparation of cell re-selection;
a quality threshold for reporting a measurement;
a reference signal received power threshold for reporting a measurement;
a reference signal received quality threshold for reporting a measurement;
a leaving condition for leaving a radio base station;
an entering condition for entering a radio base station; and
a minimum stable reception threshold for reporting a measurement.

9. A radio communication device comprising:
a memory configured to store information specifying whether a radio base station is a radio base station which allows handover to another radio base station.

10. The radio communication device of claim 9,
wherein the information is information specifying whether the radio base station is a radio base station which allows handover to another radio base station of a pre-defined type.

11. The radio communication device of claim 10,
wherein the pre-defined type is a type of radio base station that allows connection only to one or more pre-defined radio communication devices.

12. The radio communication device of claim 9, further comprising:
a receiver circuit configured to receive the information specifying whether a radio base station is a radio base station which allows handover to another radio base station.

13. The radio communication device of claim 12,
wherein the receiver circuit is further configured to receive the information via a System Information Message of a radio base station.

14. The radio communication device of claim 12,
wherein the receiver circuit is further configured to receive the information on a common control channel.

15. The radio communication device of claim 9,
wherein the memory is further configured to store at least one information selected from a group of information consisting of:
a maximum number of radio base stations a radio communication device shall measure for at least one of the preparation of handover and the preparation of cell re-selection;
a maximum number of radio base stations a radio communication device shall report measurement results on for at least one of the preparation of handover and the preparation of cell re-selection;
a maximum number of radio base stations of a pre-defined type a radio communication device shall measure for at least one of the preparation of handover and the preparation of cell re-selection;
a maximum number of radio base stations of a pre-defined type a radio communication device shall report measurement results on for at least one of the preparation of handover and the preparation of cell re-selection;
a maximum number of closed subscriber group radio base stations a radio communication device shall measure for preparing handover;
a maximum number of closed subscriber group radio base stations a radio communication device shall report measurement results on for at least one of the preparation of handover and the preparation of cell re-selection;
a quality threshold for reporting a measurement;
a reference signal received power threshold for reporting a measurement;
a reference signal received quality threshold for reporting a measurement;
a leaving condition for leaving a radio base station;
an entering condition for entering a radio base station; and
a minimum stable reception threshold for reporting a measurement.

16. The radio communication device of claim 9, further comprising:
a measurement circuit configured to measure reception quality of a radio base station.

17. The radio communication device of claim 16,
wherein the measurement circuit is further configured to measure reception quality of a radio base station which is determined based on the stored information.

18. The radio communication device of claim 16, further comprising
a reporting circuit configured to report a result of a measurement of the measurement circuit.

19. The radio communication device of claim 18,
wherein the reporting circuit is further configured to report a result of a measurement of the measurement circuit based on the stored information.

20. The radio communication device of claim 9, further comprising:
a handover preparation circuit configured to determine a radio base station as a candidate for handover.

21. The radio communication device of claim 9, further comprising:
a cell re-selection preparation circuit configured to determine a radio base station as a candidate for cell re-selection.

22. The radio communication device of claim 10, further comprising:
a handover preparation circuit configured to determine a radio base station which is of a type different from the pre-defined type as a candidate for handover, in case the information specifies that the radio base station is a radio base station which does not allow handover to another radio base station of the pre-defined type.

23. The radio communication device of claim 10, further comprising:
a cell re-selection preparation circuit configured to determine a radio base station which is of a type different from the pre-defined type as a candidate for cell re-selection, in case the information specifies that the radio base station is a radio base station which does not allow handover to another radio base station of the pre-defined type.

24. The radio communication device of claim 20,
wherein the handover preparation circuit is further configured to determine a radio base station which allows handover to another radio base station as a candidate for handover.

25. The radio communication device of claim 21,
wherein the cell re-selection preparation circuit is further configured to determine a radio base station which allows handover to another radio base station as a candidate for cell re-selection.

26. A method for controlling a radio base station, the method comprising:
generating a message comprising information specifying whether a radio base station is a radio base station which allows handover to another radio base station.

27. A method for controlling a radio communication device, the method comprising:
storing information specifying whether a radio base station is a radio base station which allows handover to another radio base station.

28. A radio base station, configured to transmit information specifying whether the radio base station is a radio base station which allows handover to another radio base station.
